(19) United States
(12) Patent Application Publication
(10) Pub. No.: US 2006/0171274 A1
(43) Pub. Date: Aug. 3, 2006

(54) Method for indicating time point for replacement of a recording medium and apparatus implementing the same

(75) Inventor: Yong Sic Moon, Suwon-Si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/257,077

(22) Filed: Oct. 25, 2005

(30) Foreign Application Priority Data
Feb. 1, 2005 (KR) 2005-9303

(51) Int. Cl. G11B 5/09; G11B 7/00

(52) U.S. Cl. 369/53.2; 369/47.1

(57) ABSTRACT

A method and an apparatus for indicating a time point for replacement of a recording medium such as a digital video disc, a compact disc, a blue-ray disc or a video tape, where a reproduction end point of moving image data of a currently-reproduced unit of the recording medium (from among a plurality of units of the recording medium) is detected when reproducing moving image data stored on the plurality of units of the recording medium. A user is forewarned of a time point at which the user must replace the current unit of the recording medium with the next unit of the recording medium. The process for indicating a time point for the replacement of a unit of the recording medium, when moving image data stored on a plurality of units of the recording medium is reproduced includes reading/reproducing data recorded in at least one unit from among the plurality of units of the recording medium, reproducing the read data, and, if the number of black pixels in a current frame is higher than a predetermined level and motion vectors facing the same direction are detected in predetermined frames or more, detecting a reproduction end point of the recoding medium, and displaying a time point for replacement of the recording medium.

### CROSS-REFERENCE TO RELATED APPLICATION

This application claims the benefit under 35 U.S.C. §119(a) from Korean Patent Application No. 2005-9303, filed on Feb. 1, 2005 in the Korean Intellectual Property Office, the entire disclosure of which is hereby incorporated by reference

### BACKGROUND OF THE INVENTION

1. Field of the Invention

The present invention relates to a method for indicating a time point for replacement of a recording medium such as a digital video disc, a compact disc, a blue-ray disc or a video tape, and an apparatus utilizing the recording medium, and an apparatus implementing such a method. More particularly, the present invention relates to a method and apparatus where a time point for replacement of the recording medium is indicated, a reproduction end point of a currently-reproduced unit, such as an optical disc, of a plurality of units of the recording medium is detected, and a user is forewarned of a time point at which the user must replace the current unit (disc) with the next unit (disc).

2. Description of the Related Art

Following the current trend of a rapidly developing information society requiring a large amount of information to be recorded, many developers have conducted intensive research into optical recording devices to increase recording density of the information. The optical recording devices have been gradually developed from Compact Discs (CDs) in the 1980s to Digital Video Discs (DVDs) in the late 1990s. Recently, new recording devices, such as BDs (Blue-ray discs) using a blue laser beam or HD-DVDs, have been developed. More recently, technologies associated with optical disc devices for efficiently recording/reproducing data of the above-mentioned discs have been researched.

The above-mentioned optical disc devices detect not only motion-picture multimedia information recorded according to the Moving Picture Expert Group 2 (MPEG2) format indicative of a basic DVD format, but also multimedia information recorded according to various other formats (e.g., MPEG4, and DivX (Digital Video Express), etc.). These optical devices reproduce the read multimedia information in the form of digital video and audio signals, and output and display high-quality video and audio signals via associated devices such as TVs.

Particularly, MPEG4 supports a variety of transfer rates from 10 kbps to 1 Mbps, and has a variety of advantages, for example, extensibility, content modification, durability in erroneous environments, multimedia data access tool, and enhanced coding efficiency, etc., such that the MPEG4 is widely used as a compression CODEC of moving-image data.

It is well known to those skilled in the art that the above-mentioned DVD is indicative of an optical disc, which is manufactured to have a predetermined diameter of 12 cm, and is capable of having digitalized multimedia information including video and audio signals, which are executable during a predetermined time of about 135 minutes, recorded thereon. The DVD functions as an optical disc having the same diameter as a CD, and can store a variety of high-quality multimedia information, such as movies and TV programs, etc.

If the optical disc device such as a DVD player for reproducing multimedia information recorded on the DVD reproduces moving images (e.g., movies) having high storage capacity corresponding to at least two discs, the optical disc device is designed to recognize and reproduce only a disc seated therein, such that it unconditionally stops reproducing data of the seated disc without informing a user of the end of a disc reproduction operation at a specific time at which reproduction of a first disc is completed. As a result, a user who is unable to recognize correct information associated with moving images currently reproduced, i.e., a reproduction end point of the moving images, can insert the next disc into the optical disc device only after reproduction of the data on the first disc is completed.

Therefore, from the viewpoint of the user who views moving image data such as a movie, the user may be dissatisfied with the optical disc devices, resulting in greater inconvenience of use if the movie requires high storage capacity composed of two or more discs.

### SUMMARY OF THE INVENTION

In the description that follows, exemplary embodiments of the present invention are described with reference to a disc as a unit of the recording medium. As noted above, it will be appreciated by skilled artisans that the present invention is equally applicable to other forms of recording medium such as, for example, digital video discs, compact discs, blue-ray discs or video tapes.

Therefore, it is an exemplary aspect of the present invention to provide a method for indicating a time point for replacement of a disc. According to another exemplary aspect of the invention, a method is provided for indicating a time point for replacement of a disc, which detects a reproduction end point of moving image data of a currently-reproduced disc from among a plurality of discs when reproducing moving image data stored in the plurality of discs, such that it forewarns a user of a time point at which the user must replace the current disc with the next disc.

Additional exemplary aspects and/or advantages of the exemplary embodiments of the present invention will be set forth in part in the following description of the exemplary embodiments of the present invention and, in part, may be appreciated or learned through practice by skilled artisans from the description of the exemplary embodiments of the present invention.

In accordance with an exemplary implementation of the present invention, the above and/or other exemplary aspects of the present invention may be achieved by the provision of, for example, a method for indicating a time point for replacement of a disc, comprising reading data recorded in the disc, reproducing the read data, detecting a reproduction end point of the disc currently reproduced, and indicating a time point for replacement of the disc on the basis of the detected reproduction end point.

According to another exemplary aspect of the present invention, detecting the reproduction end point of the disc comprises detecting the number of black pixels contained in a current frame of the disc currently reproduced, determining whether the detected number of black pixels is equal to or greater than a specific number corresponding to a predetermined level, and if the detected number of black pixels is equal to or greater than the specific number, determining an ending credit indicative of the last part of the disc.

According to another exemplary aspect of the present invention, the predetermined level is indicative of a specific state in which the number of black pixels corresponds to about 20% of the number of all horizontal pixels.

According to another exemplary aspect of the present invention, the detecting the reproduction end point of the disc comprises detecting motion vectors of individual pixels in successive frames, determining whether the motion vectors of the individual pixels face the same direction in a predetermined number of frames or more, and, if the motion vectors facing the same direction are detected in the predetermined number of frames or more, determining an ending credit indicative of the last part of the disc.

According to another exemplary aspect of the present invention, the predetermined number of frames is indicative of about 600 frames.

In accordance with another exemplary aspect of the present invention, there is provided a method for indicating a time point for disc replacement when moving image data stored in a plurality of discs is reproduced, the exemplary method comprising detecting a reproduction end point of a currently-reproduced disc from among the plurality of discs, and displaying a disc replacement time point at which the currently-reproduced disc must be replaced with the next disc contained in the plurality of discs.

According to another exemplary aspect of the present invention, indicating the disc replacement time point comprises displaying predetermined caption data of “Next Disc Insertion”.

In accordance with yet another exemplary aspect of the present invention, there is provided a method for indicating a time point for disc replacement when moving image data stored in a plurality of discs is reproduced, the exemplary method comprising reading data recorded in at least one disc from among the plurality of discs, reproducing the read data, detecting the number of black pixels contained in a current frame when reproducing the data of the disc, determining whether the detected number of black pixels is equal to or greater than a specific number corresponding to a predetermined level, and, if the detected number of black pixels is equal to or greater than the specific number, displaying a time point for replacement of the disc.

In accordance with yet another exemplary aspect of the present invention, there is provided a method for indicating a time point for disc replacement when moving image data stored in a plurality of discs is reproduced, the exemplary method comprising reading data recorded in at least one disc from among the plurality of discs, reproducing the read data, detecting motion vectors of individual pixels in successive frames when reproducing the data of the disc, determining whether the motion vectors of the individual pixels face the same direction in a predetermined number of frames or more, and, if the motion vectors facing the same direction are detected in the predetermined number of frames or more, displaying a time point for replacement of the disc.

In accordance with yet another exemplary aspect of the present invention there is provided a video reproducing apparatus comprising a controller for indicating a time point for replacement of a disc, which detects a reproduction end point of moving image data of a currently-reproduced disc from among a plurality of discs when reproducing moving image data stored in the plurality of discs, such that it forewarns a user of a time point at which the user must replace the current disc with the next disc.

### BRIEF DESCRIPTION OF THE DRAWINGS

These and/or other exemplary aspects and advantages of the exemplary implementations of the present invention will become apparent and more readily appreciated from the following description of the exemplary embodiments of the present invention, taken in conjunction with the accompanying drawings in which like reference symbols indicate the same or similar components, wherein:

FIG. 1 is a block diagram illustrating an optical disc apparatus according to an exemplary implementation of the present invention;

FIG. 2 is a flow chart illustrating an exemplary implementation of a method for indicating a time point for replacement of a disc according to an exemplary embodiment of the present invention; and

FIGS. 3A˜3D are exemplary images illustrating the last and middle parts of moving images according to an exemplary implementation of the present invention.

### DETAILED DESCRIPTION OF EXEMPLARY EMBODIMENTS

Reference will now be made in detail to the exemplary embodiments of the present invention, examples of which are illustrated in the accompanying drawings, wherein, as noted above, like reference numerals refer to like elements throughout. The exemplary embodiments of the present invention are described below to explain exemplary implementation of the present invention with reference to the drawing figures.

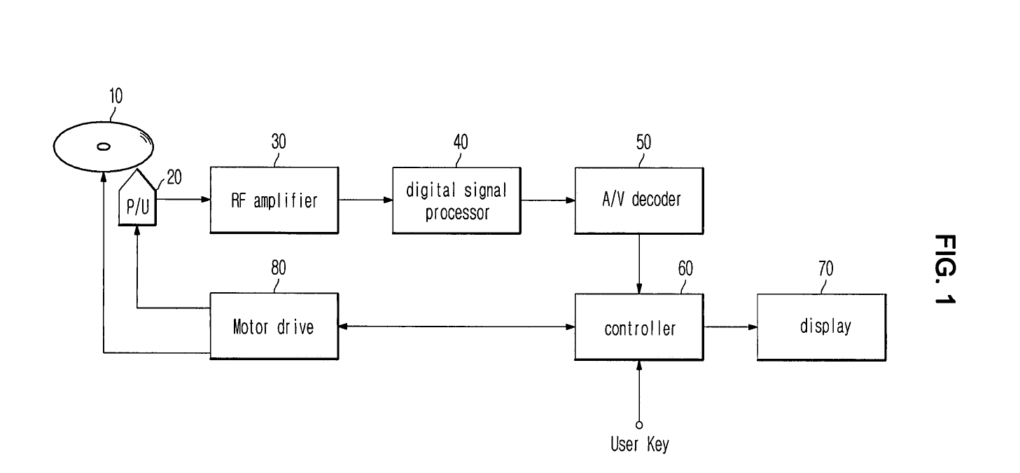

FIG. 1 is a block diagram illustrating an optical disc apparatus according to an exemplary implementation of the present invention. As shown in FIG. 1, the optical disc apparatus includes, for example, a disc 10, an optical pickup unit 20, a Radio Frequency (RF) amplifier 30, a digital signal processor 40, an Audio/Video (A/V) decoder 50, a controller 60, a display 70, and a motor drive 80.

The optical pickup unit 20 reads video and audio data streams recorded in the disc 10. The RF amplifier 30 converts data read by the optical pickup unit 20 into a high-frequency signal (e.g., an RF signal), and outputs the RF signal indicative of the high-frequency signal to the digital signal processor 40.

The digital signal processor 40 reproduces the RF signal in the form of digital video and audio signals, performs signal processing of the digital video and audio signals, and outputs the resultant video and audio signals to the A/V decoder 50. The A/V decoder 50 decompresses the reproduced digital video and audio signals, and decodes compressed moving image signals encoded in MPEG4 format, such that it generates image signals.

The controller 60 detects the number of black pixels contained in a current frame during a reproduction operation of the disc 10, and determines whether the detected number of black pixels is equal to or greater than a predetermined number corresponding to, for example, about 20% of the number of all pixels contained in the current frame. Also, the controller 60 recognizes motion vectors of individual pixels of a predetermined number of successive frames from a current frame to a previous frame, and determines whether motion vectors facing the same direction are detected from predetermined frames or more. If the controller 60 determines that the motion vectors facing the same direction are detected from the predetermined frames or more, it determines that a current time point is indicative of a reproduction end point of the disc 10 (which, may be an ending credit of moving images), such that it controls the display to indicate a time point for replacement of the disc 10. In order to perform the above-mentioned operations, the controller 60 includes, for example, a microprocessor and a memory.

Upon receiving a control signal from the controller 60, the display 70 indicates predetermined caption data of “Next Disc Insertion” so as to inform a user of a time point for replacement of the disc 10. For example, the caption data is displayed on a display unit contained in the optical disc apparatus or an LCD panel such as a general TV

The motor drive 80 varies a rotation speed of the disc 10 and a data reading position of the optical pickup unit 20 upon receiving a control signal from the controller 60.

An exemplary method for indicating a time point for disc replacement and its effect according to an exemplary aspect of the present invention will hereinafter be described with reference to the annexed drawings.

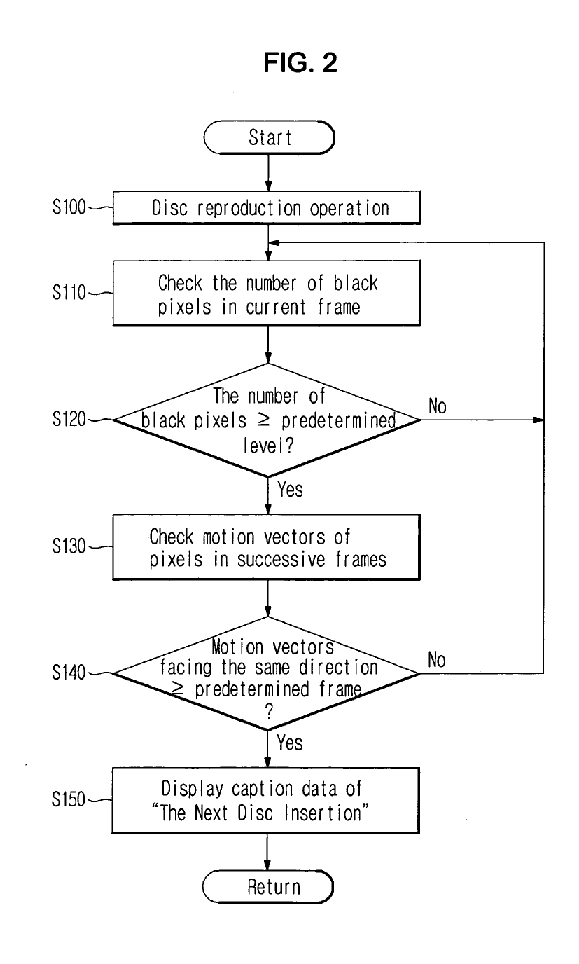

FIG. 2 is a flow chart illustrating an exemplary method for indicating a time point for replacement of a disc according to an exemplary embodiment of the present invention.

Referring to FIG. 2, if the optical disc apparatus is to reproduce moving image data (e.g., movies) recorded on a plurality of discs 10 such that a first disc 10 from among the plurality of discs 10 is seated in the optical disc apparatus, the optical disc apparatus reads video and audio data recorded on the first disc 10, reproduces digital video and audio signals using the read data, and outputs high-quality video data and high-quality audio data via an LCD panel such as a general TV.

If reproduction reaches the last part of data recorded in the disc 10 when the optical disc apparatus reproduces the data of the disc 10 at step S100, it determines the presence or absence of an ending credit, and displays a time point for replacement of the currently-reproduced disc 10. A detailed description of an exemplary implementation according to an exemplary embodiment of the present invention is as follows.

The optical disc apparatus detects the number of black pixels contained in a current frame during a reproduction operation of the disc 10 at step S110, and determines whether the detected number of black pixels is equal to or greater than a predetermined number corresponding to, for example, about 20% of the number of all pixels at step S120.

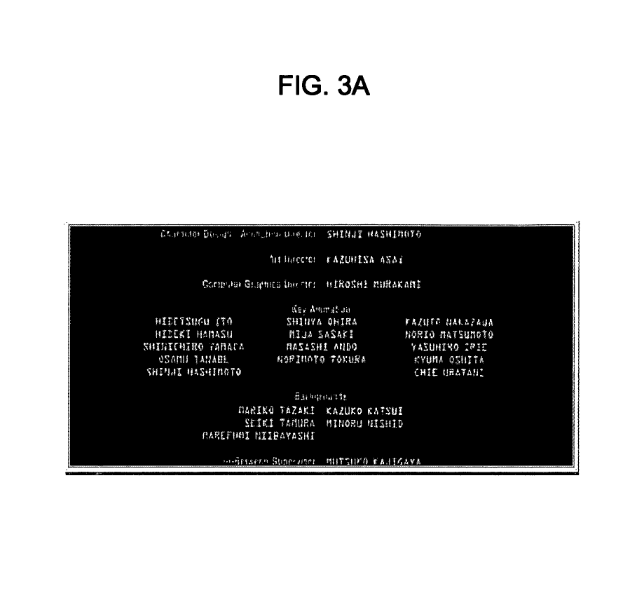

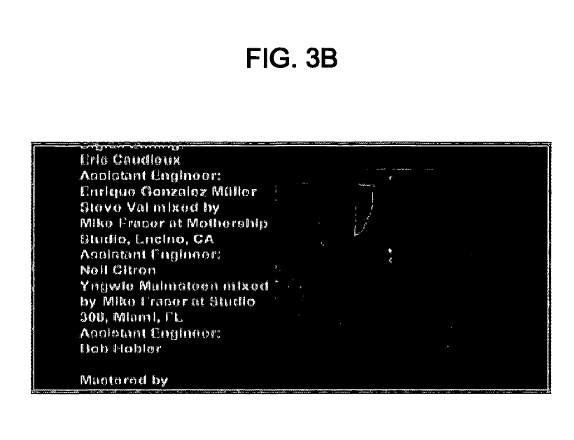

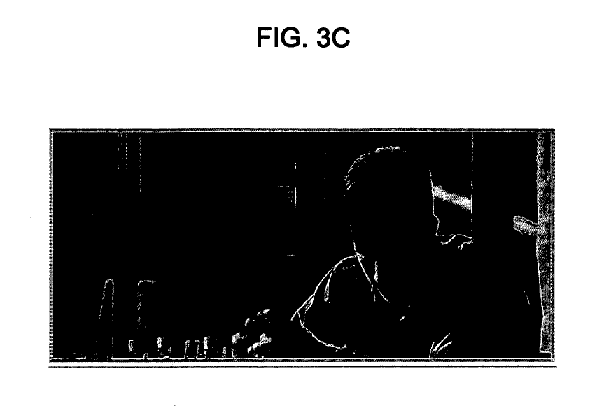

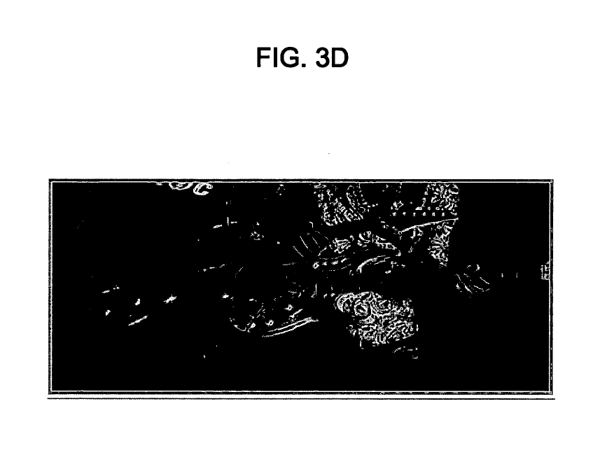

The last part of source data of all movies includes ending credit data shown in FIGS. 3A˜3B. It can be noted that the ending credit data is obviously different from a middle part of moving image data of FIGS. 3C˜3D.

Comparing FIGS. 3A˜3B with FIGS. 3C˜3D, it can be readily recognized that there are many differences between the ending credit data of FIGS. 3A˜3B and the other ending credit data of FIGS. 3C˜3D. In the case of the ending credit data of FIGS. 3A˜3B, only text data in a black background moves in the ending credit data. However, in the case of the other ending credit data of FIGS. 3C˜3D, it can be recognized that several pixels contained in individual image frames irregularly and continuously move in the ending credit data.

Considering the above-mentioned characteristics, if the number of black pixels contained in the frame is equal to or greater than a predetermined number, the controller 60 firstly determines that a data reproduction point reaches an ending credit part. In order to detect a correct ending credit part, the controller 60 recognizes motion vectors of individual pixels in a predetermined number of successive frames from a current frame to a previous frame at step S130.

In other words, in the case of the ending credit data of FIGS. 3A˜3B, it can be recognized that only text data moves in a black background and most motion vectors of individual pixels face the same direction. In the case of the ending credit data of FIGS. 3C˜3D, it can be recognized that several pixels contained in individual image frames irregularly and continuously move and motion vectors of individual pixels face different directions.

Considering the above-mentioned characteristics, the controller 60 determines whether the number of motion vectors facing the same direction is equal to or greater than a predetermined number corresponding to about 600 frames at step S140.

If the number of motion vectors facing the same direction is equal to or greater than a predetermined number corresponding to about 600 frames at step S140, the controller 60 determines that a current reproduction position is in a correct ending credit, and detects a reproduction end point of the current disc 10.

Thereafter, the controller 60 controls the display 70 to display caption data of “Next Disc Insertion” at step S150, such that the user can recognize a time point at which the current disc must be replaced with the next disc 10.

As is apparent from the above description, exemplary implementations of a method for indicating a time point for disc replacement according to exemplary embodiments of the present invention include the steps of detecting a reproduction end point of moving image data of a currently-reproduced disc from among a plurality of discs when reproducing moving image data stored in the plurality of discs, visually displaying caption data of “Next Disc Insertion”, and informing a user of a time point at which the user must replace the current disc with the next disc, resulting in greater use convenience.

Although the exemplary embodiments of the present invention are described with reference to an optical disc and an apparatus such as a DVD player for data recorded on DVDs, it is not limited to the optical disc apparatus and is also applicable to a variety of recording medium reproduction devices such as Video Cassette Recorders (VCRs), Compact Disc (CD) players, or Blue-ray (BD) disc players.

Furthermore, although a few exemplary embodiments of the present invention have been shown and described, it would be appreciated by those skilled in the art that changes and variations may be made without departing from the principles and spirit of the invention, the scope of which is defined in the claims and their equivalents.

What is claimed is:

1. A method for indicating a time point for replacement of a recording medium, comprising:
reading data recorded on the recording medium;
reproducing the read data;
detecting a reproduction end point of the recording medium; and
indicating a time point for replacement of the recording medium on the basis of the detected reproduction end point.

2. The method according to claim 1, wherein the detecting the reproduction end point of the recording medium comprises:
detecting a number of black pixels in a current frame of the recording medium;
determining whether the detected number of the black pixels is equal to or greater than a predetermined number; and
if the detected number of black pixels is equal to or greater than the predetermined number, determining an ending credit indicative of the end point of the recording medium.

3. The method according to claim 2, wherein the predetermined number is indicative of the number of black pixels corresponding to 20% of a number of all horizontal pixels.

4. The method according to claim 2, wherein the detecting the reproduction end point of the recording medium further comprises:
detecting motion vectors of individual pixels in successive frames;
determining whether the motion vectors of the individual pixels face the same direction in at least a predetermined number of frames; and
if the motion vectors facing the same direction are detected in the at least predetermined number of frames, determining the ending credit indicative of the end part of the recording medium.

5. The method according to claim 4, wherein the predetermined number of frames is indicative of about 600 frames.

6. A method for indicating a time point for recording medium replacement when moving image data stored on a plurality of units of the recording medium is reproduced, the method comprising:
detecting a reproduction end point of a currently-reproduced unit of the recording medium from the plurality of units of the recording medium; and
displaying the recording medium replacement time point at which the currently-reproduced unit of the recording medium is to be replaced with a next unit of the plurality of units of the recording medium.

7. The method according to claim 6, wherein the displaying the recording medium replacement time point comprises:
displaying a caption data indicative of the recording medium replacement time point.

8. A method for indicating a time point for recording medium replacement when moving image data stored on a plurality of units of the recording medium is reproduced, the method comprising:
reading data recorded on at least one unit of the recording medium from the plurality of units of the recording medium;
reproducing the read data;
detecting a number of black pixels contained in a current frame of the data recorded on the at least one unit of the recording medium;
determining whether the detected number of black pixels is equal to or greater than a predetermined number;
if the detected number of black pixels is equal to or greater than the predetermined number, displaying a time point for replacement of the at least one unit of the recording medium.

9. The method according to claim 8, further comprising:
detecting motion vectors of individual pixels in successive frames;
determining whether the motion vectors of the individual pixels face the same direction in at least a predetermined number of frames; and
if the motion vectors facing the same direction are detected in the at least predetermined number of frames, displaying the time point for replacement of the at least one unit of the recording medium.

10. A method for indicating a time point for recording medium replacement when moving image data stored on a plurality of units of the recording medium is reproduced, the method comprising:
reading data recorded on at least one unit of the recording medium from the plurality of units of the recording medium;
reproducing the read data;
detecting motion vectors of individual pixels in successive frames of the data recorded on the at least one unit of the recording medium;
determining whether the motion vectors of the individual pixels face the same direction in at least a predetermined number of frames; and
if the motion vectors facing the same direction are detected in the at least the predetermined number of frames, displaying a time point for replacement of the at least one unit of the recording medium.

11. The method according to claim 10, further comprising:
detecting the number of black pixels contained in a current frame when reproducing the data of the disc;
determining whether the detected number of black pixels is equal to or greater than a specific number corresponding to a predetermined level; and
if the detected number of black pixels is equal to or greater than the specific number, displaying a time point for replacement of the disc.

12. The method according to claim 11, wherein the predetermined level is indicative of a specific state in which the number of black pixels corresponds to 20% of the number of all horizontal pixels.

13. The method according to claim 10, wherein the predetermined number of frames is indicative of about 600 frames.

14. The method according to claim 1, wherein the recording medium comprises at least one of a digital video disc, a compact disc, a blue-ray disc and a video tape.

15. The method according to claim 8, wherein the recording medium comprises at least one of a digital video disc, a compact disc, a blue-ray disc and a video tape.

16. The method according to claim 10, wherein the recording medium comprises at least one of a digital video disc, a compact disc, a blue-ray disc and a video tape.

17. A video reproducing apparatus comprising:
a reader for reading digital video data from a recording medium;
a processor for producing a video signal for the digital video data;
a decoder for degenerating an image signal for display; and
a controller for detecting a reproduction end point of the recording medium and indicating a time point for replacement of the recording medium on the basis of the detected reproduction end point.

18. The video reproducing apparatus according to claim 17, wherein detecting the reproduction end point comprises:
detecting a number of black pixels in a current frame of the image signal;
determining whether the detected number of the black pixels is equal to or greater than a predetermined number; and
if the detected number of black pixels is equal to or greater than the predetermined number, determining an ending credit indicative of the end point of the recording medium.

19. The video reproducing apparatus according to claim 18, wherein detecting the reproduction end point further comprises:
detecting motion vectors of individual pixels in successive frames;
determining whether the motion vectors of the individual pixels face the same direction in at least a predetermined number of frames; and
if the motion vectors facing the same direction are detected in the at least predetermined number of frames, determining the ending credit indicative of the end point of the recording medium.

20. The video reproducing apparatus according to claim 18, wherein the predetermined number is indicative of the number of black pixels corresponding to 20% of a number of all horizontal pixels.

21. The video reproducing apparatus according to claim 19, wherein the predetermined number of frames is indicative of about 600 frames.

22. The video reproducing apparatus according to claim 17, wherein the recording medium comprises at least one of a digital video disc, a compact disc, a blue-ray disc and a video tape.
